(19) United States
(12) Patent Application Publication
(10) Pub. No.: US 2014/0114925 A1
(43) Pub. Date: Apr. 24, 2014

(54) PICTORIAL SYMBOL REGISTRATION APPARATUS AND PICTORIAL SYMBOL REGISTRATION METHOD

(71) Applicant: Nariaki MIURA, Kawasaki-shi (JP)

(72) Inventor: Nariaki MIURA, Kawasaki-shi (JP)

(21) Appl. No.: 13/657,208

(22) Filed: Oct. 22, 2012

(51) Int. Cl. G06F 17/30

(52) U.S. Cl. CPC G06F 17/30253
USPC 707/687

(57) ABSTRACT

A pictorial symbol registration apparatus determines whether reading data of a pictorial symbol used in a character conversion process is embedded in an image file containing image data indicating the pictorial symbol, and stores the reading data to be associated with the image data in a dictionary file such as a dictionary file used in the character conversion process when it is determined that the reading data is embedded, thereby easily realizing registration of the pictorial symbol.

### BACKGROUND OF THE INVENTION

1. Field of the Invention

The present invention relates to a pictorial symbol registration apparatus and pictorial symbol registration method suitable for use when a pictorial symbol (or pictogram) is registered in a character conversion dictionary or the like in a terminal such as a mobile phone, a mobile information terminal, or a personal computer.

2. Description of Related Art

In current terminals such as mobile phones, mobile information terminals, or personal computers, an image having the same (or different) size as a character may be mainly inserted in place of the character. This image is treated as image data to be inserted into an HTML (Hyper Text Mark-up Language) mail sentence (e.g., see Japanese Unexamined Patent Application, First Publication No. 2009-169786).

Further, in the terminal described above, a pictorial symbol may be input by an operation similar to Kana-to-Kanji conversion (e.g., see Japanese Patent Unexamined Application, First Publication No. 2000-148748). In such a terminal, for example, an image of a vegetable such as a carrot may be read by converting a character string “vegetable” and inserted into a sentence.

Further, technology of appending reading data such as “furigana” to a predetermined character contained in a scanned image is shown in Japanese Patent Unexamined Application, First Publication No. 2010-146143.

However, the technologies used in the terminals as described above have the following problems.

First, pictorial symbols that can be used by a manipulation similar to Kana-to-Kanji conversion are limited to pictorial symbols registered in advance. For example, even when an image file for a pictorial symbol is newly downloaded, registration of a character string for designating an image, i.e., reading data, may not be performed. Accordingly, the newly downloaded pictorial symbol cannot be used by an operation similar to the Kana-to-Kanji conversion and should be directly selected from the image file.

Second, when reading data for designating a newly downloaded pictorial symbol (i.e., a character string for conversion into the pictorial symbol) is set and registered in the same conversion dictionary as that for Kana-to-Kanji conversion, a registration task takes time and effort. Particularly, since character input using ten keys or a touch panel is performed due to the size limit of the mobile terminal, it is difficult for a user to register reading data corresponding to an image for a pictorial symbol.

As described above, displaying pictorial symbols, for example, in e-mail has been performed in the terminal such as the mobile terminal. However, additional registration of pictorial symbols is only registration by an image, and it is common to select the pictorial symbol from a selection file for the image.

Further, while conversion of a pictorial symbol using conversion technology similar to the Kana-to-Kanji conversion has also been proposed, there is a problem in that an added pictorial symbol cannot be registered for this conversion technology or the registration takes time and effort. Particularly, since there are a number of types of pictorial symbols, it is necessary to easily convert the pictorial symbols and to easily register additional pictorial symbols in order to promote use.

### SUMMARY OF THE INVENTION

An object of the present invention is to provide a pictorial symbol registration apparatus and a pictorial symbol registration method capable of resolving the above problems.

A pictorial symbol registration apparatus of the present invention includes a determination unit that determines whether reading data for designating a pictorial symbol used in a character conversion process is contained in an image file containing image data indicating the pictorial symbol; and a storage unit that stores the image data and the reading data to be associated with each other in a dictionary file used in the character conversion process when the determination unit determines that the reading data is contained in the image file.

According to the present invention, since the reading data is stored to be associated with the image data in the dictionary file used in the character conversion process using the reading data of the pictorial symbol used in the character conversion process contained in the image file containing image data indicating the pictorial symbol, a user need not input a character string for designating the pictorial symbol (i.e., reading data such as Kana) when registering the pictorial symbol. Accordingly, it is possible to easily perform pictorial symbol registration.

### BRIEF DESCRIPTION OF THE DRAWINGS

FIG. 1 is a block diagram illustrating a pictorial symbol registration apparatus according to an embodiment of the present invention;

FIG. 2 is a flowchart illustrating an example of a process in the embodiment illustrated in FIG. 1; and

FIG. 3 is a diagram illustrating an example of a configuration of a downloaded image file in an embodiment of the present invention.

### DESCRIPTION OF EXEMPLARY EMBODIMENTS

Hereinafter, exemplary embodiments of the present invention will be described with reference to the accompanying drawings.

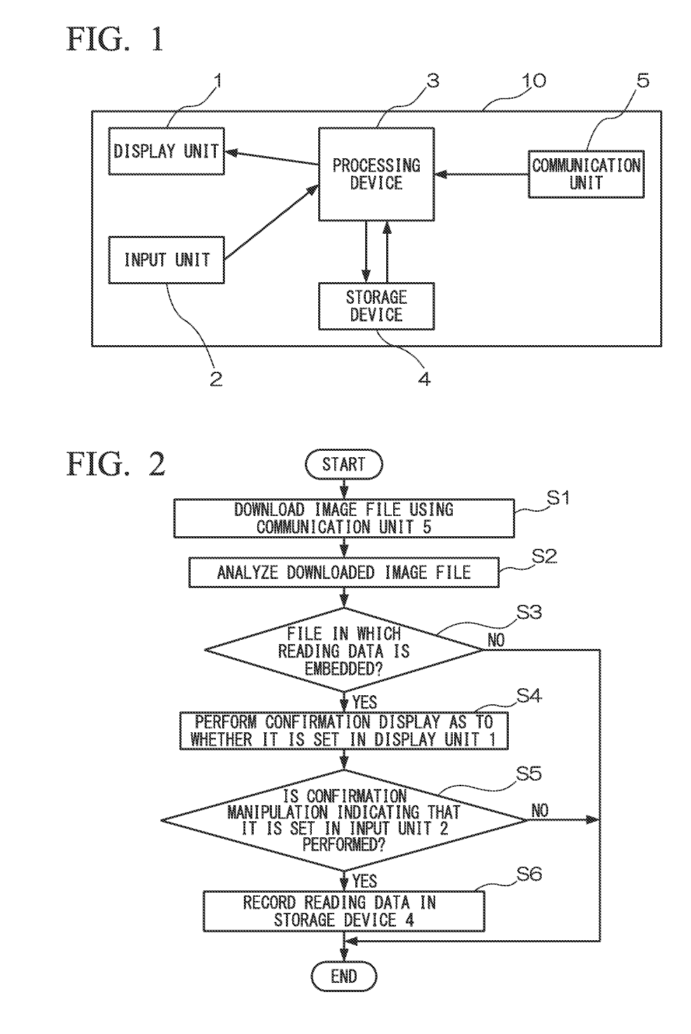

FIG. 1 is a block diagram illustrating an example of a configuration when a pictorial symbol registration apparatus according to an embodiment of the present invention is realized by a mobile phone 10. This pictorial symbol registration apparatus may be configured using a CPU (central processing unit) in the mobile phone 10, peripheral devices of the CPU, and a program executed by the CPU. In the pictorial symbol registration apparatus in FIG. 1, a configuration realized by hardware and a program (software) is represented by some blocks divided according to functions. In addition, the mobile phone 10 has various functions such as a voice call function and a communication function, but such functions are omitted in FIG. 1.

Further, the pictorial symbol registration apparatus of the present invention is not limited to the realization within the mobile phone and may be realized by other devices, such as a mobile information terminal, a personal computer, or a word processor. Further, the pictorial symbol registration apparatus of the present invention may be configured as a program (or an application for document production, e-mail production or the like, or a program included as a part in another program) and provided via a predetermined storage medium or a communication line.

Referring to FIG. 1, the mobile phone 10 of FIG. 1 includes a display unit 1, an input unit 2, a processing device 3, a storage device 4, and a communication unit 5.

The display unit 1 includes a display device or a printing device. The input unit 2 includes, for example, ten keys or a touch panel. The processing device 3 performs, for example, a process of extracting reading data contained in an image file that contains image data indicating a pictorial symbol. The processing device 3 controls each unit and realizes each function using a predetermined program (software).

In the present embodiment, the pictorial symbol is a figure or an image different from characters such as alphanumeric characters, Kanji, Kana, and symbols to which character codes have been assigned. This pictorial symbol is used together with (or in place of) characters such as Kanji, Kana, and symbols in a document such as an e-mail. In the present embodiment, an example of the pictorial symbol includes image data inserted into an HTML mail. Further, the reading data is a character string (or a character) for obtaining a character after conversion (particularly, a pictorial symbol in the present embodiment) in a character conversion process such as a Kana-to-Kanji conversion process. That is, the reading data is a character string for designating a pictorial symbol and corresponds to “furigana” for designating Kanji in Kana-to-Kanji conversion. For example, in the example described in Background of the Invention, a character string “vegetable” associated with image data of a vegetable such as a carrot is reading data.

The storage device 4 stores files used in a character conversion process such as Kana-to-Kanji conversion, such as a dictionary file for Kanji conversion, a dictionary file containing a plurality of reading data associated with image data indicating pictorial symbols, and a plurality of image files each containing the image data indicating a pictorial symbol.

Here, the “dictionary file used in a character conversion process containing a plurality of reading data associated with the image data indicating pictorial symbols” described above stores a plurality of sets of address information indicating storage positions of image files (or image data) containing image data of pictorial symbols and reading data corresponding to the pictorial symbols to be associated with each other. Specifically, the pictorial symbols may be registered as the dictionary file and used in the character conversion process. That is, in the character conversion process, when a user inputs reading data to instruct conversion of the reading data, image data associated with the reading data stored in the dictionary file is selected.

In this embodiment, when the processing device 3 determines that the reading data of the pictorial symbol used in the character conversion process is contained (embedded) in an image file in which the image data indicating a pictorial symbol is stored, storage addresses of the image data of pictorial symbol and the reading data are stored to be associated with each other in the dictionary file used in the character conversion process, which is stored in the storage device 4. Further, a downloaded image file (i.e., an image file in which the reading data is embedded) or the image data contained in the image file is stored in the storage device 4.

Further, when an HTML mail is produced, the image file in which the reading data is embedded is produced within an HTML description (e.g., through text conversion).

The communication unit 5 communicates the image file containing the image data indicating a pictorial symbol with, for example, an external server. The communication unit 5 performs infrared communication, communication using a non-contact IC (integrated circuit) card, or communication via a WLAN (wireless local area network) to perform transmission and reception of a desired file via a wired or wireless public telephone or communication network. The communication unit 5 connects to a server such as a Web server or a personal computer, which is not shown, via the communication line, and downloads, for example, an image file from the server.

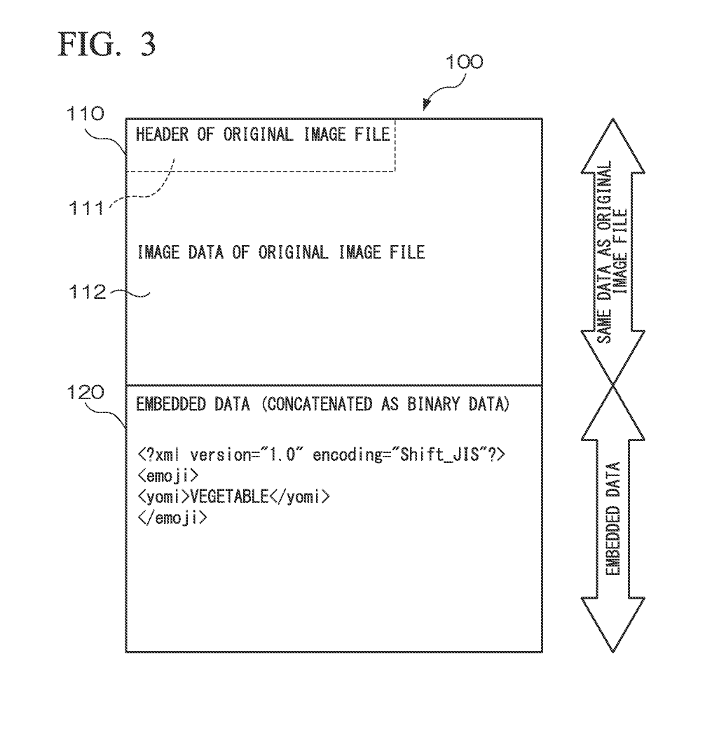

Next, an operation example of the mobile phone 10 and a configuration of the image file in the present embodiment will be described with reference to FIGS. 2 and 3. This example is an operation example when the mobile phone 10 is connected to an external server via the communication unit 5, and an image file for a pictorial symbol is downloaded from the server and registered in the storage device 4 of the mobile phone 10.

In the external server, a plurality of image files each containing image data indicating a pictorial symbol and reading data of the pictorial symbol used in the character conversion process are stored in a predetermined storage device in advance. A search function is provided in a web site opened by this server and each image file is registered similar to a normal image file in which the reading data is not embedded.

Embedding of the reading data into the image file is performed in a format as illustrated in FIG. 3. Referring to FIG. 3, an image file 100 in which the reading data is embedded contains data 110 as the same as a normal image file containing image data 112 indicating pictorial symbols, and embedded data 120 containing reading data as binary data concatenated after the data 110. The embedded data 120 is described in an XML (Extensible Markup Language) format and the reading data is concatenated as binary data after the data 110 of a file of a JPEG (Joint Photographic Experts Group) image or the like, as illustrated in FIG. 3. The format of the image is not limited to JPEG.

When the reading data is “vegetable,” the reading data may be described as illustrated in FIG. 3. Further, the data 110 is the same data as an original image file (i.e., before the embedded data 120 is concatenated), and includes a header 111 of the original image file, and image data 112 of the original image file.

In FIG. 3, “<?xml version=“1.0” encoding=“Shift JIS”?>” is an XML declare statement. “<emoji>,” “<yomi>vegetable</yomi>” and “</emoji>” are XML instances (body). “<emoji>” and “</emoji>” are a start tag and an end tag that indicate a description of an element (information) for the reading data of the pictorial symbol, and mean that the element for the reading data of the pictorial symbol is described between the start tag and the end tag. “<yomi>” and “</yomi>” are a start tag and an end tag indicating the description of the reading data of the pictorial symbol, and mean that the reading data of the pictorial symbol is described between the start tag and the end tag. Also, a character string “vegetable” described between “<yomi>” and “</yomi>” is the reading data of the pictorial symbol used in the character conversion process.

Next, a process when the reading data of the pictorial symbol is registered in the mobile phone 10 will be described with reference to FIG. 2. Here, when a user makes a manipulation of the input unit 2 to download the image file 100 containing the image data indicating the pictorial symbol illustrated in FIG. 3 from the external server while confirming display of the display unit 1, the image file 100 is downloaded by the communication unit 5 (step S1).

Next, the processing device 3 analyzes the downloaded image file 100, and determines whether the reading data of the pictorial symbol used in the character conversion process is embedded in the image file 100 containing the image data indicating the pictorial symbol (step S2). The analysis and the determination by the processing device 3 are performed as follows.

In this example, the downloaded image file has a configuration of the image file 100 illustrated in FIG. 3. The processing device 3 searches for data corresponding to the tag “<emoji>” from an end of the image file 100 to a start. If the data is found, the processing device 3 determines that the image file 100 is an image file in which the reading data is embedded, and if the data is not found, the processing device 3 determines that the image file 100 is an image file in which the reading data is not embedded.

Further, even when the data corresponding to the tag “<emoji>” is found, the processing device 3 may evaluate if data subsequent to “<emoji>” is correct as an XML format to detect mismatch, i.e., whether “<emoji>” is contained accidentally.

When the downloaded file is the image file in which the reading data is embedded (“YES” in step S3), the image data contained in the image file is displayed on the display unit 1, and “Is a pictorial symbol <vegetable> set?” and a confirmation display as to whether it is set or not is performed (step S4). Here, when the user selects “Set” in the input unit 2 (“YES” in step S5), the reading data (“vegetable”) contained in the embedded data 120 of the image file 100 is extracted and then stored in a dictionary file used in a character conversion process such as Kana-to-Kanji conversion, which is stored in the storage device 4, to be associated with the image data (step S6). In step S6, the image file 100 (or data obtained by converting the image data 112 to a predetermined format) is stored in the storage device 4, and data associated with data such as an address indicating a storage position of the image file 100 containing corresponding image data corresponding to the reading data (or corresponding image data) within the storage device 4 is stored in the dictionary file used in the character conversion process.

Through the above process, the mobile phone 10 can download the image file 100 containing the image data 112 indicating the pictorial symbol from the server, and register the reading data as the pictorial symbol by only one selection manipulation.

Further, in the analysis of the image file 100 in step S2, when there is an XML element not supported by the mobile phone 10 (i.e., the terminal), it may be neglected. Further, DTD (Document Type Definition) may be used in an XML data part in order to further ensure the validity of XML data.

Further, to further simplify manipulation, the display “Is a pictorial symbol <vegetable> set?” by the display unit 1 in step S4 and the selection by the input unit 2 in step S5 may be omitted and the reading data may be registered immediately after the download and the analysis.

According to the present embodiment, the following effects can be obtained. As a first effect, reading data registration as a pictorial symbol can be performed by only one selection manipulation after downloading even in a limited input/output device such as a normal mobile phone (e.g., with only a 2-inch screen and ten keys). Further, the one selection manipulation may also be omitted.

As a second effect, since the image file 100 in which the reading data is added can be treated as the same image file as an image file in which the reading data is not added for each device, the image file 100 can be treated as a normal image in a personal computer, a mobile phone, a server or the like that is currently available (i.e., that has no function of the present invention). Transfer means is not limited to downloading in e-mail or HTTP (HyperText Transfer Protocol), and all transfer means used for image files (e.g., communication using a non-contact IC card, storage and hand-delivery on a removable memory card, or communication using a general-purpose interface such as a USB (Universal Serial Bus)) may be used. Accordingly, the image file can be distributed while avoiding putting a load on or being billed for using a communication infrastructure such as a mobile telephone network.

As a third effect, in the case of a mechanism of transferring the image file, the reading data and the corresponding image data can be simultaneously transferred, unlike the reading data being embedded outside the image file in HTML. For example, according to a normal-image-file transfer procedure, the image data, including the reading data, can be delivered by transfer using OBEX (Object Exchange; object (file) exchange protocol using infrared communication or near field wireless communication), transfer of only an image file from a USB mass storage, or the like. Further, when an e-mail into which a pictorial symbol is inserted is transmitted between users, the other user can also register the pictorial symbol, including the image data and the read data, by one manipulation. Further, since it does not depend on communication businesses, the same maneuverability can be provided between different businesses.

As a fourth effect, since the downloading and the registering are easy, for example, an image for a pictorial symbol is posted for downloading in an official site of a manufacturer instead of the pictorial symbol being pre-installed in a terminal, thereby conserving usage of a ROM (read only memory) before shipment. Further, for a content provider, since it can be used as a pictorial symbol like a normal image when a model is a non-compatible model and it becomes data using the reading data when a model is a compatible model, there is an advantage in that it is unnecessary to produce a page or data for each model.

Next, other embodiments of the present invention will be described. Further, differences between the other embodiments and the above-described embodiment will be described hereinafter.

(1) In order to prevent duplicate registration of a pictorial symbol, an ID (identification information) specific to the pictorial symbol may be embedded in an image file. When pictorial symbols have the same ID, the pictorial symbols are the same. The same pictorial symbol is not registered, making it possible to prevent data transmitted and received by e-mail or the like from being doubly registered. Alternatively, the duplicate registration may be prevented by comparison of image file sizes, comparison of all binary data, or comparison of results of performing predetermined calculation on binary data instead of the ID.

(2) A plurality of reading data may be embedded in the image file. For example, a plurality of reading data may be designated as “eggplant” and “vegetable” for an image of an eggplant. For example, a plurality of reading data can be designated for one image data by changing a part “<yomi>vegetable</yomi>” in the description within the embedded data 120 of FIG. 3 into “<yomi>eggplant</yomi> and <yomi>vegetable</yomi>.” In this case, the entire description of the embedded data 120 is as follows.

<?xml version=“1.0” encoding=“Shift_JIS”?> <emoji>

<yomi>eggplant</yomi> <yomi>vegetable</yomi> </emoji>

(3) The reading data may be used as a character string for alternative display. For example, in a terminal incapable of displaying an image, an indication that the pictorial symbol is used can be made by displaying a Kana character (string) corresponding to the reading data as an alternative to the pictorial symbol. Further, if the reading data is used for voice reading by a voice synthesis process, a visually impaired person can understand the intent of the pictorial symbol.

(4) In order to suppress an amount of used data, the data may be mounted in a binary format instead of being embedded in the XML. For example, if a format in which the reading data is concatenated after data “EMJ<” (here, “EMJ<” is assumed to be a single-byte character) and ends with “>” (here, “>” is assumed to be a single-byte character) is used, the present function can be realized by only real reading data plus 5 bytes (since single-byte characters such as “<” and “>” can be used as data delimiters because there are only hiragana in the reading data).

(5) Since there is a freely available header area in some image formats, the reading data may be embedded in the XML or the above-described binary format in the header area.

(6) The terminal may have a function of producing the image file with the reading data. That is, a mobile phone or the like may have a function of producing an image file in which the reading data of the pictorial symbol is embedded in an image file containing image data indicating the pictorial symbol based on a correspondence relationship between the image data indicating the pictorial symbol and the reading data indicating the reading, which is stored in the dictionary file for pictorial symbol registration used in the character conversion process. That is, the mobile phone or the like may have a function of newly producing the image file 100 as illustrated in FIG. 3 from the image data and the corresponding reading data. When the mobile phone or the like has this function and, for example, when there is a desire to register the same pictorial symbol in a changed model of a mobile phone, the same format of image file can be transferred and the same pictorial symbol used until then can be used. That is, backup and transfer of the pictorial symbol and the reading data can be performed.

Further, the configuration of the above-described embodiment and the “determination unit” in the present invention correspond to the processing device 3 that performs the determination process in step S3 in FIG. 2 based on a processing result of step S2. The “storage unit” in the present invention corresponds to the storage device 4 in which the reading data is stored in step S6 FIG. 2.

Further, a program for realizing a pictorial symbol registration function in the present embodiment may be recorded in a computer-readable recording medium, and the program recorded in this recording medium may be read and executed by a computer system. Further, the “computer system” stated herein is assumed to include an OS and hardware such as peripheral devices. Further, the “computer system” includes a WWW system including a homepage providing environment (or a display environment). Also, the “computer-readable recording medium” includes a portable medium such as a flexible disk, a magnetic optical disc, a ROM, or a CD-ROM, and a storage device such as a hard disk embedded in a computer. Also, the “computer-readable recording medium” includes a medium that holds a program for a predetermined time, such as a volatile memory (RAM) in a computer system consisting of a server and a client when a program is transmitted via a network such as the Internet or a communication line such as telephone line.

Further, the above-described program may be a program for realizing some of the above-described functions. Alternatively, the program may be a program capable of realizing the above-described functions through combination with a program previously stored in a computer system, i.e., a differential file (a differential program).

What is claimed is:

1. A pictorial symbol registration apparatus comprising:
a determination unit that determines whether reading data for designating a pictorial symbol used in a character conversion process is contained in an image file containing image data indicating the pictorial symbol; and
a storage unit that stores the image data and the reading data in association with each other in a dictionary file used in the character conversion process when the determination unit determines that the reading data is contained in the image file.

2. The pictorial symbol registration apparatus according to claim 1, wherein identification information uniquely assigned to the image data is contained in the image file.

3. The pictorial symbol registration apparatus according to claim 1, wherein a plurality of reading data are stored per one image data in the image file.

4. The pictorial symbol registration apparatus according to claim 1, wherein the pictorial symbol registration apparatus has a function of producing an image file in which the image data indicating the pictorial symbol and the reading data of the pictorial symbol are stored to be associated with each other, based on a corresponding relationship between the image data indicating the pictorial symbol and the data indicating reading of the image data stored in the dictionary file used in the character conversion process.

5. A pictorial symbol registration method comprising:
determining whether reading data for designating a pictorial symbol used in a character conversion process is contained in an image file containing image data indicating the pictorial symbol; and
storing the image data and the reading data in association with each other in a dictionary file used in the character conversion process when it is determined that the reading data is contained in the image file.

6. A computer-readable recording medium having a pictorial symbol registration program stored thereon, the pictorial symbol registration program causing a computer to execute:
determining whether reading data for designating a pictorial symbol used in a character conversion process is contained in an image file containing image data indicating the pictorial symbol; and
storing the image data and the reading data in association with each other in a dictionary file used in the character conversion process when it is determined that the reading data is contained in the image file.
